(19) United States
(12) Patent Application Publication
(10) Pub. No.: US 2011/0094350 A1
(43) Pub. Date: Apr. 28, 2011

(54) Pivot head ratchet wrench

(76) Inventor: Chung Cheng Yang, Taichung Hsien (TW)

(21) Appl. No.: 12/589,596

(22) Filed: Oct. 26, 2009

(51) Int. Cl. B25B 13/46; B25B 23/16

(52) U.S. Cl. 81/63.1; 81/177.8

(57) ABSTRACT

A ratchet wrench includes a handle pivotally coupled to a head, a shaft rotatably attached to the head and having a gear and a bevel gear, two pawls engaged in the head for engaging with the gear and for determining the driving direction of the shaft by the head and the handle, an actuating member for selectively disengaging either of the pawls from the gear, a cartridge attached to the shaft, and a driving member rotatably attached to the cartridge and having another bevel gear engaged with the bevel gear of the shaft for allowing the driving member to be rotated by the shaft and the bevel gears and for allowing the pivot head ratchet wrench to be easily used to drive or unthread the fasteners located at a higher position.

### BACKGROUND OF THE INVENTION

1. Field of the Invention

The present invention relates to a ratchet wrench, and more particularly to a pivot head ratchet wrench including a driving member arrangeable in parallel to the handle of the pivot head ratchet wrench for allowing the pivot head ratchet wrench to be easily used to drive or unthread the fasteners located at a higher position.

2. Description of the Prior Art

Typical flexible or pivot head ratchet wrenches comprise a working head pivotally or rotatably coupled to a lever arm or handle and a locking mechanism disposed between the lever arm or handle and the working head for securing the working head in the angled position.

For example, U.S. Pat. No. 4,794,829 to Mesenhoeller discloses one of the typical ratchet-type wrenches also comprising a working head pivotally or rotatably coupled to a lever arm or handle, and an axially arranged spindle in the lever arm operates a locking mechanism that may be provided for securing the working head in the angled position.

However, the driving member which is provided or engaged in the working head is normally perpendicular to the lever arm such that the driving member of the working head may not be easily engaged with the fasteners located at a higher position and also may not be used to drive or unthread the fasteners located at the higher position.

U.S. Pat. No. 6,138,533 to Turtle discloses another typical wrench and extension bar comprising a wrench head pivotally or rotatably coupled to an extension bar and having a tubular member which includes a longitudinal slot for engaging the fasteners into the tubular member.

However, the wrench head may not be easily engaged with the fasteners or tool members located at a higher position and also may not be used to drive or unthread the fasteners located at the higher position.

U.S. Pat. No. 6,216,565 to McCann discloses a further typical driving cartridge securing mechanism to wrench handle comprising a driving cartridge pivotally or rotatably coupled to a handle at a shaft and rotatable in a plane parallel to that of the handle.

However, the driving cartridge may only be rotated in the plane parallel to that of the handle such that the driving member which is provided or engaged in the driving cartridge may not be easily engaged with the fasteners located at a higher position and also may not be used to drive or unthread the fasteners located at the higher position.

U.S. Pat. No. 6,871,569 to Chen discloses a further typical tool having a rotatable driving head and comprising a driving head having a shank pivotally or rotatably coupled to a handle with a shaft.

However, similarly, the driving member which is provided or engaged in the driving head is normally perpendicular to the handle such that the driving member of the driving head may not be easily engaged with the fasteners located at a higher position and also may not be used to drive or unthread the fasteners located at the higher position.

The present invention has arisen to mitigate and/or obviate the afore-described disadvantages of the conventional flexible ratchet wrenches.

### SUMMARY OF THE INVENTION

The primary objective of the present invention is to provide a pivot head ratchet wrench including a driving member arrangeable in parallel to the handle of the pivot head ratchet wrench for allowing the pivot head ratchet wrench to be easily used to drive or unthread the fasteners located at a higher position.

In accordance with one aspect of the invention, there is provided a ratchet wrench comprising a head including a chamber formed therein, a handle pivotally coupled to the head with a pivot axle, a shaft rotatably attached to the head and including a gear provided on the shaft and engaged in the chamber of the head, two pawls pivotally engaged in the chamber of the head and each including one end for engaging with the gear of the shaft and for determining a driving direction of the shaft by the head and the handle, at least one spring biasing member engaged with the pawls for biasing the pawls to engage with the gear of the shaft, an actuate device including an actuating member engaged within the chamber of the head, and a lever disposed outside the head and coupled to the actuating member for rotating the actuating member to engage with either of the pawls and to selectively disengaging either of the pawls from the gear of the shaft in order to determine the driving direction of the shaft by the head and the handle, a first bevel gear attached to the shaft and rotated in concert with the shaft, a cartridge attached to the shaft and including a compartment formed therein for rotatably receiving the first bevel gear, and including a conduit formed therein and communicative with the compartment of the cartridge, and a driving member rotatably received and engaged in the conduit of the cartridge, and including a second bevel gear rotatably received in the compartment of the cartridge and engaged with the first bevel gear for allowing the driving member to be rotated and driven by the shaft and the bevel gears and for allowing the pivot head ratchet wrench to be easily used to drive or unthread the fasteners located at a higher position.

The cartridge includes an aperture formed therein and communicative with the compartment of the cartridge for rotatably engaging with a first end of the shaft, and includes a cover attached to the cartridge and having a hole formed therein for rotatably engaging with a second end of the shaft and for stably and rotatably coupling and retaining or securing the cartridge to the pivot head with the shaft.

The shaft includes a number of teeth or a serrated segment formed thereon, and the first bevel gear includes a serrated portion formed in an inner portion thereof and engaged with the serrated segment of the shaft for solidly mounting the first bevel gear to the shaft and for preventing the first bevel gear from being rotated relative to the shaft.

The cartridge includes a partition attached thereto for retaining the first bevel gear and the second bevel gear in the compartment of the cartridge and for stably retaining the first bevel gear and the second bevel gear in engagement with each other. The actuating member is preferably selected from a cam-shaped actuating member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a pivot head ratchet wrench in accordance with the present invention;

FIG. 2 is an upper perspective view of the pivot head ratchet wrench;

FIG. 3 is a partial cross sectional view of the pivot head ratchet wrench taken along lines 3-3 of FIG. 2;

FIG. 4 is a partial cross sectional view of the pivot head ratchet wrench taken along lines 4-4 of FIG. 3;

FIGS. 5, 6 are partial cross sectional views similar to FIG. 4, illustrating the operation of the ratchet mechanism of the pivot head ratchet wrench; and

FIGS. 7, 8 are the other partial cross sectional views illustrating the operation of the pivot head ratchet wrench for the fasteners or tool members.

### DETAILED DESCRIPTION OF THE PREFERRED EMBODIMENT

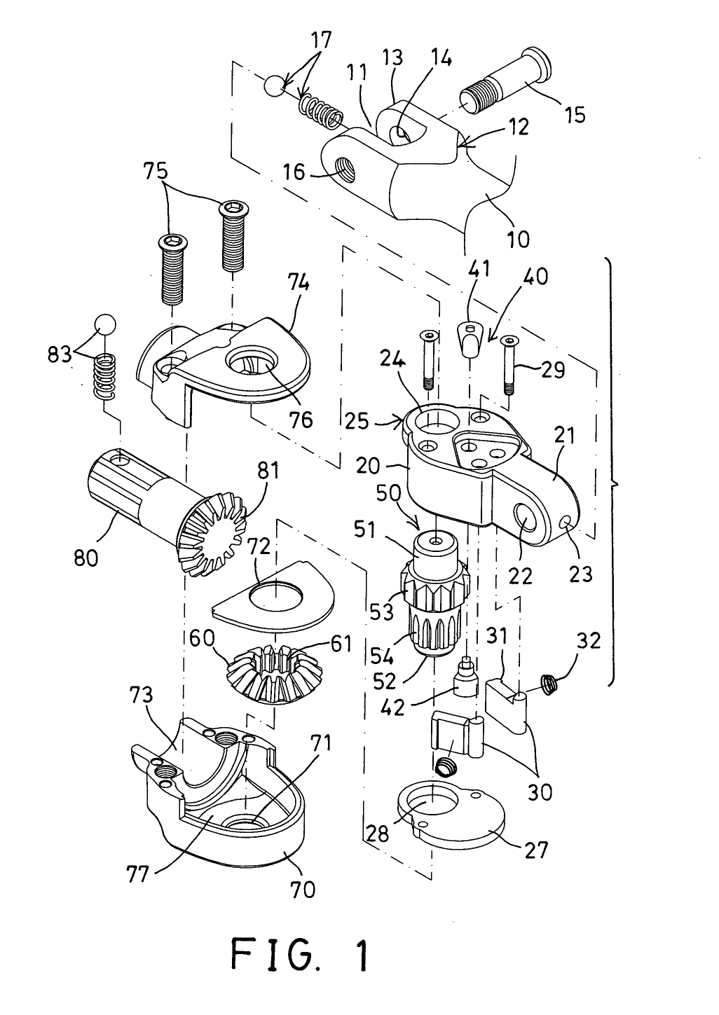

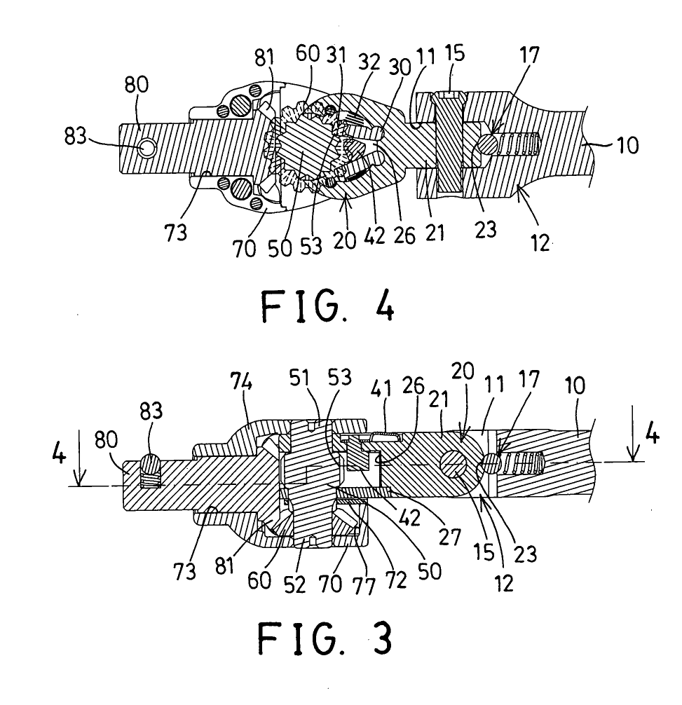

Referring to the drawings, and initially to FIGS. 1-4, a pivot head ratchet wrench in accordance with the present invention comprises a lever arm or handle 10 including a notch 11 formed in one end portion 12 thereof and formed or defined by or between two limbs 13, an orifice 14 is formed in one of the limbs 13 for receiving or engaging with a pivot axle 15, the pivot axle 15 is engaged through the notch 11 of the handle 10 and threaded or engaged with a screw hole 16 that is formed or provided in the other limb 13 of the handle 10. A spring biased projection 17 may further be provided and engaged in the handle 10 and partially extendible or engageable into the notch 11 of the handle 10, best shown in FIGS. 3-6.

A flexible or pivot head 20 includes a shank 21 engaged into the notch 11 of the handle 10 and having a hole 22 formed in the shank 21 for receiving or engaging with the pivot axle 15 and for pivotally or rotatably coupling or attaching or mounting the shank 21 of the pivot head 20 to the handle 10 and for allowing the pivot head 20 to be rotated relative to the handle 10, and includes one or more cavities 23 formed in the shank 21 for engaging with the spring biased projection 17 which may be engaged with either of the cavities 23 for anchoring or positioning the pivot head 20 to the handle 10 at the selected angular position and for allowing the pivot head 20 to be tilted relative to the handle 10 or to be perpendicular to the handle 10 selectively.

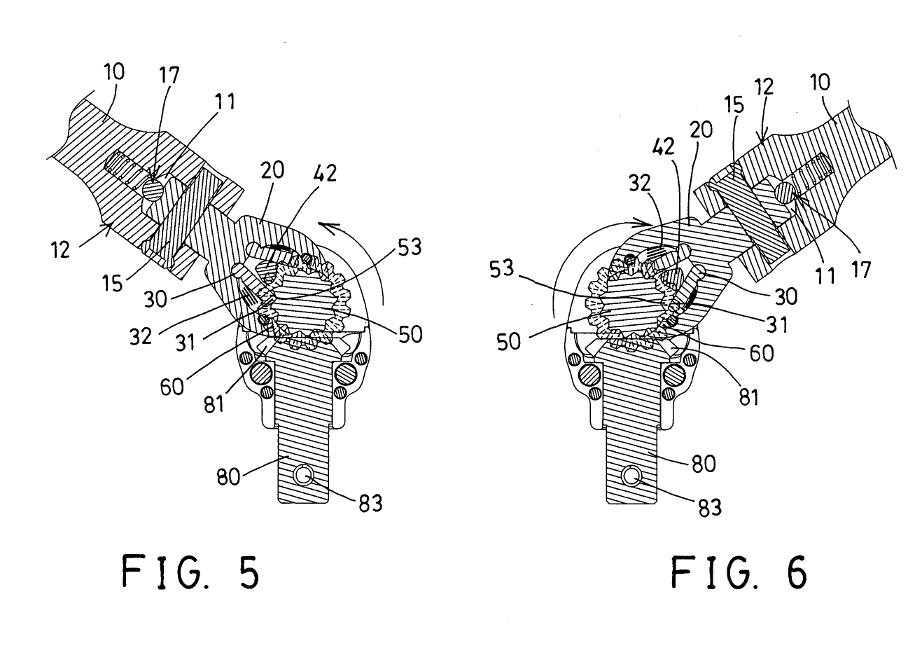

The pivot head 20 includes an opening 24 formed in a free end portion 25 thereof, and includes a chamber 26 formed therein (FIGS. 3, 4), and includes a cap 27 attached or mounted or secured to the lower portion of the pivot head 20 for blocking or enclosing the chamber 26 of the pivot head 20, and includes a hole 28 formed in the cap 27 and aligned with the opening 24 of the pivot head 20. For example, the cap 27 may be mounted or secured to the pivot head 20 with one or more latches or fasteners 29 (FIG. 1). A shaft 50 includes an upper portion or one end 51 pivotally or rotatably engaged within the opening 24 of the pivot head 20 and thus pivotally or rotatably attached or mounted to the pivot head 20, and includes a lower portion or the other end 52 extended out of the pivot head 20, and includes a gear 53 formed or provided on the shaft 50 and pivotally or rotatably engaged within the chamber 26 of the pivot head 20, as shown in FIG. 3.

Two pawls 30 are pivotally or rotatably engaged within the chamber 26 of the pivot head 20, and each includes one end 31 engageable with the gear 53 of the shaft 50 and for determining the driving direction of the shaft 50 by the pivot head 20 and the handle 10, and one or more (such as two) spring biasing members 32 are engaged with the pawls 30 respectively for biasing the pawls 30 to engage with the gear 53 of the shaft 50. A switch or control or actuate device 40 includes an actuating member 42, such as a cam-shaped or cam type actuating member 42 disposed or engaged within the chamber 26 of the pivot head 20, and a lever 41 disposed outside the pivot head 20 and attached or mounted or secured or coupled to the actuating member 42 for moving or rotating or actuating the actuating member 42 to engage with either of the pawls 30 and to selectively disengaging either of the pawls 30 from the gear 53 of the shaft 50.

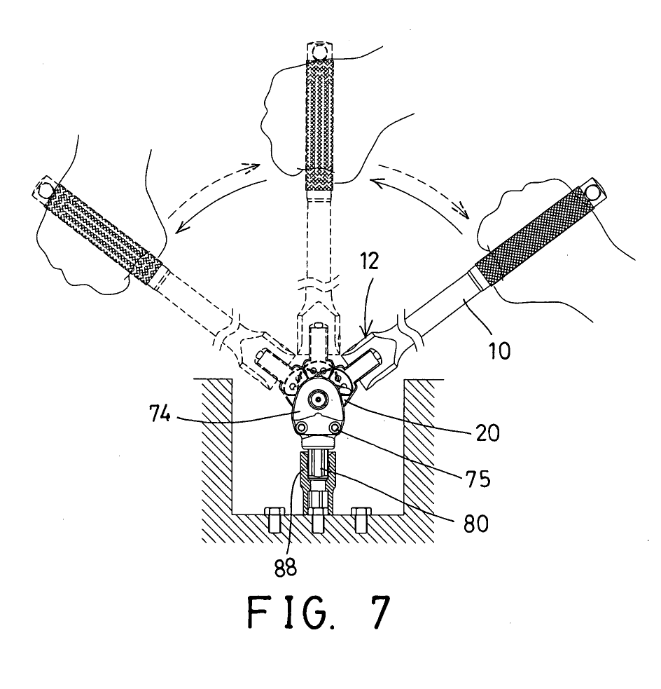

In operation, as shown in FIGS. 4-6, when one of the pawls 30 is engaged with the actuating member 42 and is disengaged from the gear 53 of the shaft 50 with the actuating member 42, the shaft 50 may be rotated or driven in one direction, such as the counter-clockwise direction by the pivot head 20 and the handle 10 (FIG. 5), and the pivot head 20 and the handle 10 are freely to rotate relative to the shaft 50 in the other direction, such as the clockwise direction. As shown in FIG. 6, when the other pawl 30 is disengaged from the gear 53 of the shaft 50 with the actuating member 42, the shaft 50 may be rotated or driven in the other direction, such as the clockwise direction by the pivot head 20 and the handle 10, and the pivot head 20 and the handle 10 are freely to rotate relative to the shaft 50 counterclockwise at this moment.

A cartridge 70 includes a compartment 77 formed therein (FIGS. 1, 3) for pivotally or rotatably receiving the other end 52 of the shaft 50, and includes an aperture 71 formed therein and communicative with the compartment 77 of the cartridge 70 for pivotally or rotatably engaging with the other end 52 of the shaft 50, and includes a conduit 73 laterally formed therein and also communicative with the compartment 77 of the cartridge 70 and arranged perpendicular to the shaft 50 and the aperture 71 of the cartridge 70, and includes a cover 74 attached or mounted or secured to the upper portion of the cartridge 70 with one or more latches or fasteners 75 (FIG. 1) and having a hole 76 formed therein for pivotally or rotatably receiving or engaging with the one end 51 of the shaft 50 and thus for stably and pivotally or rotatably coupling or securing the cartridge 70 to the pivot head 20 with the shaft 50.

A worm or bevel gear 60 is rotatably received or disposed in the compartment 77 of the cartridge 70 and is solidly attached or mounted or secured to the shaft 50, for example, the shaft 50 includes a number of teeth or a serrated portion or segment 54 formed or provided thereon, and the bevel gear 60 includes a number of teeth or a serrated portion 61 formed or provided thereon for engaging with the serrated portion or segment 54 of the shaft 50 and for solidly attaching or mounting or securing the bevel gear 60 to the shaft 50 and for preventing the bevel gear 60 from being rotated relative to the shaft 50, and for allowing the bevel gear 60 to be rotated in concert with the shaft 50. As shown in FIGS. 1 and 3, a partition 72 may be attached or mounted or secured to the cartridge 70 for stably retaining the bevel gear 60 in the compartment 77 of the cartridge 70 and/or for separating the bevel gear 60 from the gear 53 of the shaft 50, and/or for stably retaining the bevel gear 60 and the bevel gear 53 of the shaft 50 in suitable engagement with each other.

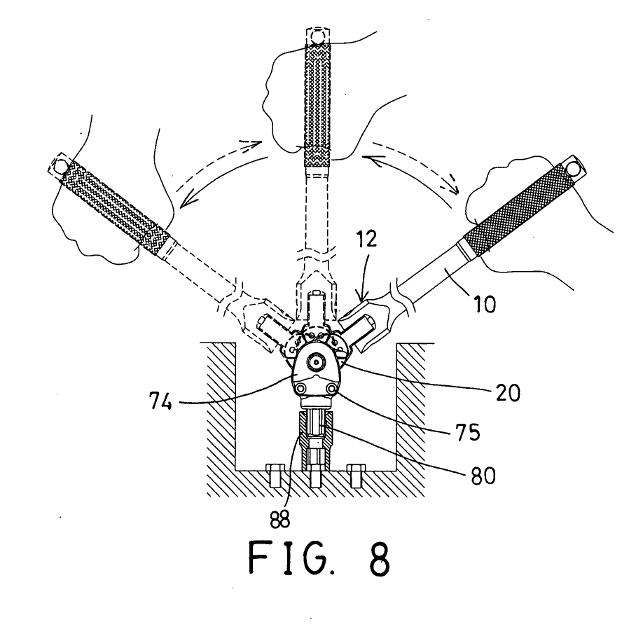

A driving shank or member 80 is rotatably received or engaged in the conduit 73 of the cartridge 70, and includes another worm or bevel gear 81 rotatably received or disposed in the compartment 77 of the cartridge 70 and meshed or engaged with the worm or bevel gear 60 for allowing the driving member 80 to be selectively rotated or driven by the shaft 50 and the bevel gear 60, the driving member 80 may further include a spring biased projection 83 for engaging with a fastener or tool element 88 that is to be selectively rotated or driven by the driving member 80 (FIGS. 7, 8) and for stably coupling or attaching or mounting or retaining the fastener or tool element 88 to the driving member 80, and for allowing the fastener or tool element 88 to be solidly rotated or driven by the driving member 80. The bevel gear 81 of the driving member 80 may also be stably retained in the compartment 77 of the cartridge 70 with the partition 72.

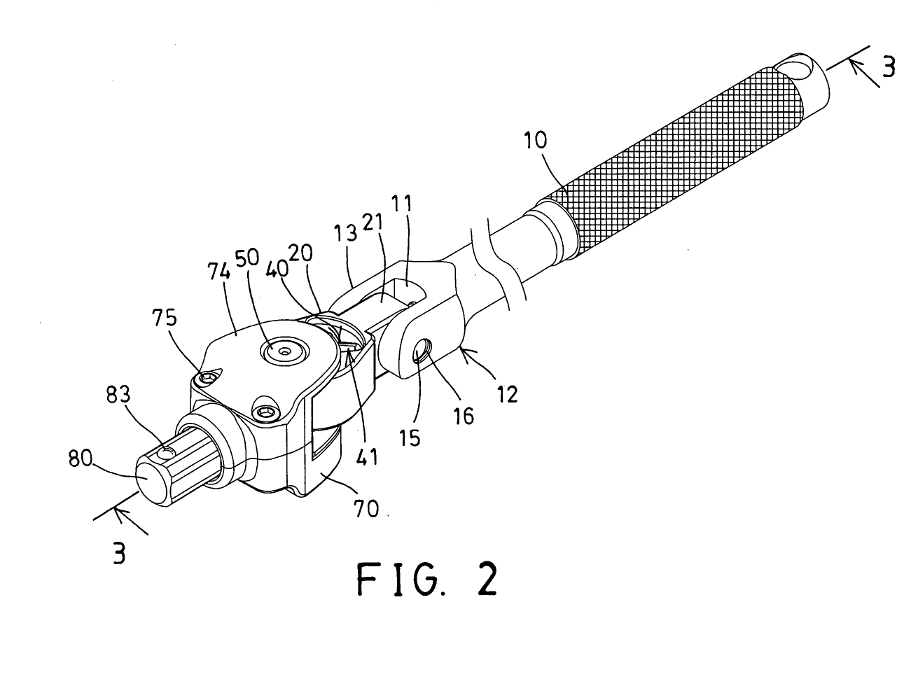

It is to be noted that, as shown in FIGS. 2-4, the driving member 80 may be arranged or positioned in a status parallel to the handle 10, and perpendicular to the shaft 50, and the handle 10 is rotatable relative to the pivot head 20 and the cartridge 70 for allowing the cartridge 70 and the pivot head 20 to be suitably engaged into the deeper working position as shown in FIGS. 7 and 8, and for allowing the fastener or tool element 88 and the driving member 80 and the cartridge 70 and the pivot head 20 to be suitably or solidly rotated or driven by the handle 10. The driving member 80 may be selected from a screw driver bit, a square driving shank, a hexagonal or octangular driving shank, a socket, or other driving elements.

Accordingly, the pivot head ratchet wrench in accordance with the present invention includes a driving member arrangeable in parallel to the handle of the pivot head ratchet wrench for allowing the pivot head ratchet wrench to be easily used to drive or unthread the fasteners located at a higher position.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ratchet wrench comprising:
a head including a chamber formed therein,
a handle pivotally coupled to said head with a pivot axle,
a shaft rotatably attached to said head and including a gear provided on said shaft and engaged in said chamber of said head,
two pawls pivotally engaged in said chamber of said head and each including one end for engaging with said gear of said shaft and for determining a driving direction of said shaft by said head and said handle,
at least one spring biasing member engaged with said pawls for biasing said pawls to engage with said gear of said shaft,
an actuate device including an actuating member engaged within said chamber of said head, and a lever disposed outside said head and coupled to said actuating member for rotating said actuating member to engage with either of said pawls and to selectively disengaging either of said pawls from said gear of said shaft in order to determine the driving direction of said shaft by said head and said handle,
a first bevel gear attached to said shaft and rotated in concert with said shaft,
a cartridge attached to said shaft and including a compartment formed therein for rotatably receiving said first bevel gear, and including a conduit formed therein and communicative with said compartment of said cartridge, and
a driving member rotatably received and engaged in said conduit of said cartridge, and including a second bevel gear rotatably received in said compartment of said cartridge and engaged with said first bevel gear for allowing said driving member to be rotated and driven by said shaft and said bevel gears.

2. The ratchet wrench as claimed in claim 1, wherein said actuating member is a cam-shaped actuating member.

3. The ratchet wrench as claimed in claim 1, wherein said cartridge includes an aperture formed therein and communicative with said compartment of said cartridge for rotatably engaging with a first end of said shaft, and includes a cover attached to said cartridge and having a hole formed therein for rotatably engaging with a second end of said shaft and for stably and rotatably coupling said cartridge to said pivot head with said shaft.

4. The ratchet wrench as claimed in claim 1, wherein said shaft includes a serrated segment formed thereon, and said first bevel gear includes a serrated portion engaged with said serrated segment of said shaft for mounting said first bevel gear to said shaft.

5. The ratchet wrench as claimed in claim 1, wherein said cartridge includes a partition attached thereto for retaining said first bevel gear and said second bevel gear in said compartment of said cartridge.
